(19) United States
(12) Patent Application Publication
(10) Pub. No.: US 2020/0193184 A1
(43) Pub. Date: Jun. 18, 2020

(54) IMAGE PROCESSING DEVICE AND IMAGE PROCESSING METHOD

(71) Applicant: DENSO TEN Limited, Kobe-shi (JP)

(72) Inventors: Yasutaka OKADA, Kobe-shi (JP); Hiroaki SANO, Kobe-shi (JP); Tetsuo YAMAMOTO, Kobe-shi (JP); Atsushi YOSHIHARA, Kobe-shi (JP); Jun KANETAKE, Kawasaki-shi (JP); Ryo YOSHIMURA, Fukuoka-shi (JP); Tomoki SHIDORI, Kobe-shi (JP)

(73) Assignee: DENSO TEN Limited, Kobe-shi (JP)

(21) Appl. No.: 16/574,391

(22) Filed: Sep. 18, 2019

(30) Foreign Application Priority Data
Dec. 14, 2018 (JP) 2018-234804

(51) Int. Cl. G06K 9/00; G06K 9/32; G06K 9/46

(52) U.S. Cl. CPC G06K 9/00812; G06K 9/4676; G06K 9/4628; G06K 9/3233

(57) ABSTRACT

An image processing device includes: a detection unit configured to detect, from an image, a pair of delimiting lines for delimiting a parking space; and an estimation unit configured to estimate an inclination angle of an actual road surface on which the pair of delimiting lines is provided based on deflection angles of the pair of delimiting lines on a road surface, the pair of delimiting lines being included in the at least one delimiting line detected by the detection unit.

### CROSS-REFERENCE TO RELATED APPLICATIONS

This application is based upon and claims the benefit of priority from prior Japanese patent application No. 2018-234804, filed on Dec. 14, 2018, the entire contents of which are incorporated herein by reference.

### BACKGROUND

### Technical Field

The present disclosure relates to an image processing device and an image processing method.

### Related Art

In recent years, as automatic driving technology is developed, an image processing device configured to detect a parking space for parking a vehicle from an image obtained by capturing a surrounding of the vehicle is spread. In the image processing device, delimiting lines for delimiting the parking space are detected from the image, and the parking space is detected on the basis of the detected delimiting lines (for example, see JP-A-2017-87758).

In a case in which a road surface, on which delimiting lines are provided, is inclined with respect to a road surface on which a host vehicle having a camera configured to capture an image travels, for example, it is necessary for the image processing device to detect positions and angles of the delimiting lines with respect to the host vehicle, considering an inclination angle of the road surface.

### SUMMARY

However, in the related art, in order to detect the inclination angle of the road surface, it is necessary to use concurrently other sensors such as a monocular camera, a radar laser, a stereo camera and the like, for example, and it is difficult to estimate the inclination angle of the road surface only with an image captured by the monocular camera.

An aspect of an exemplary embodiment has been made in view of the above situation, and an object thereof relates to provide an image processing device and an image processing method capable of estimating an inclination angle of a road surface, on which a delimiting lines are provided, from an image captured by a monocular camera.

According to an aspect of the present disclosure, there is provided an image processing device including: a detection unit configured to detect, from an image, a pair of delimiting lines for delimiting a parking space; and an estimation unit configured to estimate an inclination angle of an actual road surface on which the pair of delimiting lines is provided based on deflection angles of the pair of delimiting lines on a road surface, the pair of delimiting lines being included in the at least one delimiting line detected by the detection unit.

The image processing device and the image processing method in accordance with an aspect of the exemplary embodiment may estimate the inclination angle of the road surface, on which the delimiting lines are provided, from the image captured by the monocular camera.

### BRIEF DESCRIPTION OF DRAWINGS

Exemplary embodiment(s) of the present invention will be described in detail based on the following figures, wherein:

FIG. 1A depicts an example in which an image processing device according to an exemplary embodiment is mounted;

FIG. 1B depicts an outline of an image processing method according to the exemplary embodiment is mounted;

FIG. 2 is a block diagram of the image processing device according to the exemplary embodiment;

FIG. 3 is a block diagram of a parking space detection unit according to the exemplary embodiment;

FIG. 4 illustrates an estimation sequence of an inclination angle;

FIG. 5 illustrates the estimation sequence of the inclination angle; and

FIG. 6 is a flowchart depicting an example of processing executed by the parking space detection unit.

### DETAILED DESCRIPTION

Hereinbelow, the image processing device and the image processing method in accordance with an exemplary embodiment will be described in detail with reference to the accompanying drawings. In the meantime, the present disclosure is not limited to the exemplary embodiment.

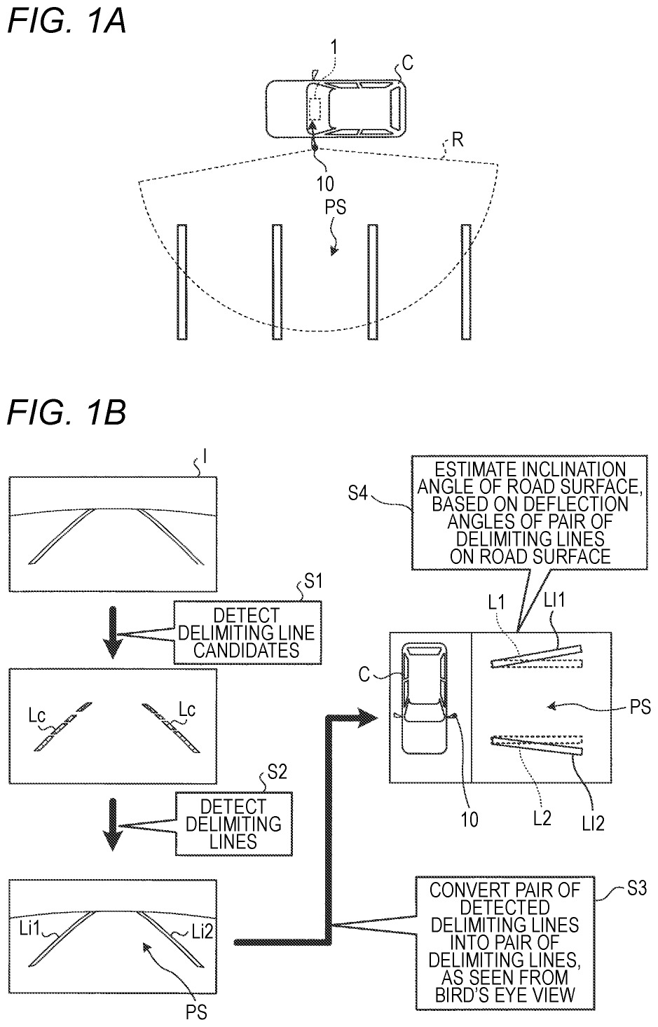

First, an outline of an image processing device of an exemplary embodiment is described with reference to FIGS. 1A and 1B. FIG. 1A depicts an example in which an image processing device is mounted. Also, FIG. 1B depicts an outline of an image processing method. The image processing method is executed by the image processing device 1 shown in FIG. 1A.

As shown in FIG. 1A, the image processing device 1 of the exemplary embodiment is mounted to a host vehicle (hereinbelow, referred to as ‘vehicle C’) having a vehicle-mounted camera 10 mounted thereto, and is configured to detect a parking space PS from a captured image (hereinbelow, simply referred to as ‘image’) captured by the vehicle-mounted camera 10.

The vehicle-mounted camera 10 is a monocular imaging device including an imaging element such as a CCD (Charge Coupled Device), a CMOS (Complementary Metal Oxide Semiconductor) and the like, for example, and configured to capture a surrounding of the vehicle C. Also, for a lens of the vehicle-mounted camera 10, a wide-angle lens such as a fish-eye lens is adopted, for example. Thereby, the vehicle-mounted camera 10 can capture parking spaces PS existing in an imaging area R of a wide angle, as shown in FIG. 1A.

Meanwhile, in the example of FIG. 1A, the vehicle-mounted camera 10 is a left side camera configured to capture a left side of the vehicle C. However, the vehicle-mounted camera 10 includes a front camera configured to capture a front of the vehicle C, a rear camera configured to capture a rear of the vehicle C, and a right side camera configured to capture a right side of the vehicle C.

When detecting the parking spaces PS, the image processing device 1 detects delimiting line candidates, which are candidates of a delimiting line L for delimiting each parking space PS, from the image and detects each of the parking spaces PS on the basis of the detected delimiting line candidates. At this time, for example, when the delimiting line candidates are discretely detected or discontinuously detected, the parking space PS may not be detected.

Therefore, the image processing device 1 of the exemplary embodiment is configured to integrate the detected delimiting line candidates, based on a predetermined integration condition. Thereby, the image processing device 1 of the exemplary embodiment can improve detection accuracy of the parking space.

Specifically, as shown in FIG. 1B, the image processing device 1 first detects delimiting line candidates Lc from an image I (step S1). For example, the image processing device 1 detects the delimiting line candidates Lc, based on edge lines connecting edge points obtained by performing edge emphasizing for the image I.

Then, the image processing device 1 detects, as the delimiting line candidate Lc, edge lines corresponding to boundaries between the delimiting line and a road surface in the image I. That is, the delimiting line candidate Lc is a pair of edge lines corresponding to left and right ends of the delimiting line in a width direction.

Then, the image processing device 1 integrates the delimiting line candidates Lc detected in step S1, based on a predetermined integration condition, and detects delimiting lines Li1 and Li2 (step S2). Thereby, the image processing device 1 can detect, as the parking space PS, an area between the pair of delimiting lines Li1 and Li2.

When parking the vehicle C in the parking space PS detected in this way by automatic driving, it is necessary for the image processing device 1 to detect positions and angles of the delimiting lines Li1 and Li2 with respect to the vehicle C and to notify the same to an upper level ECU (Electronic Control Unit) (which will be described later) configured to control the automatic driving.

In this case, the image processing device 1 converts the pair of detected delimiting lines Li1 and Li2 into a pair of delimiting lines LI1 and LI2, as seen from a bird's eye view (step S3), and detects positions and angles of the delimiting lines LI1 and LI2 with respect to the vehicle C.

At this time, a general image processing device assumes that a road surface, on which delimiting lines are provided, is not inclined with respect to a road surface on which the vehicle C travels, and converts the delimiting lines detected from the image into delimiting lines on the assumed road surface of which an inclination angle is 0°, as seen from a bird's eye view.

For this reason, according to the general image processing device, in a case in which the road surface, on which the delimiting lines are provided, is inclined with respect to the road surface on which the vehicle C is positioned, a pair of delimiting lines L1 and L2 shown with the dotted line, which is in a parallel state if the road surface is not inclined, is converted into the pair of delimiting lines LI1 and LI2 deviating from the parallel state.

In this case, since the upper level ECU parks the vehicle C in the parking space PS, based on the pair of delimiting lines LI1 and LI2 of which positions and angles with respect to the vehicle C are different from actual positions and angles, it is not possible to perform correct parking by the automatic driving.

Here, deflection angles of the delimiting lines LI1 and LI2 on the road surface, as seen from a bird's eye view after the conversion, depend on the inclination angle of the road surface, on which the delimiting lines Li1 and Li2 are provided, with respect to the road surface on which the vehicle C travels.

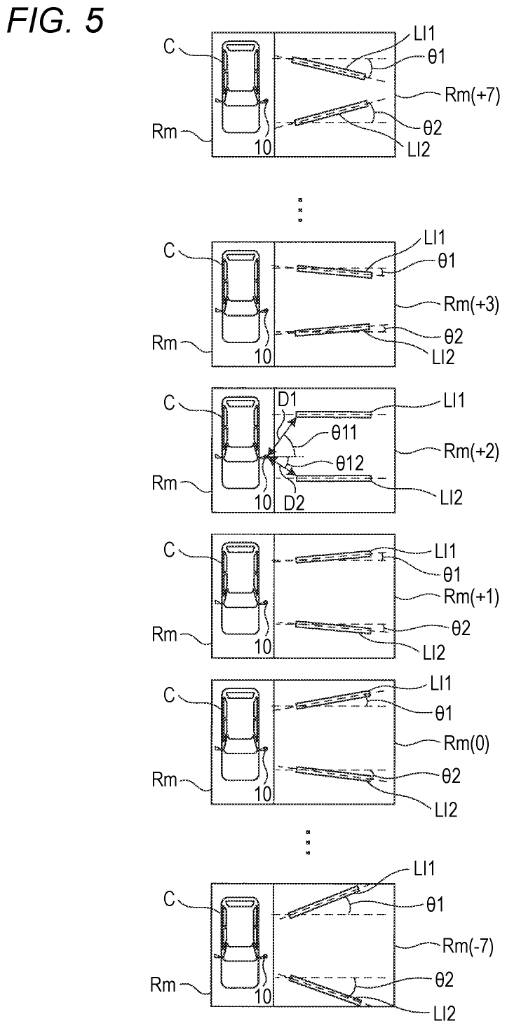

Therefore, the image processing device 1 of the exemplary embodiment estimates an inclination angle of the road surface, based on the deflection angles of the delimiting lines LI1 and LI2 on the road surface (step S4). Thereby, the image processing device 1 can estimate the inclination angle of the road surface, on which the delimiting lines are provided, from the image captured by the monocular camera. A specific example of the estimation sequence of the inclination angle will be described with reference to FIG. 5.

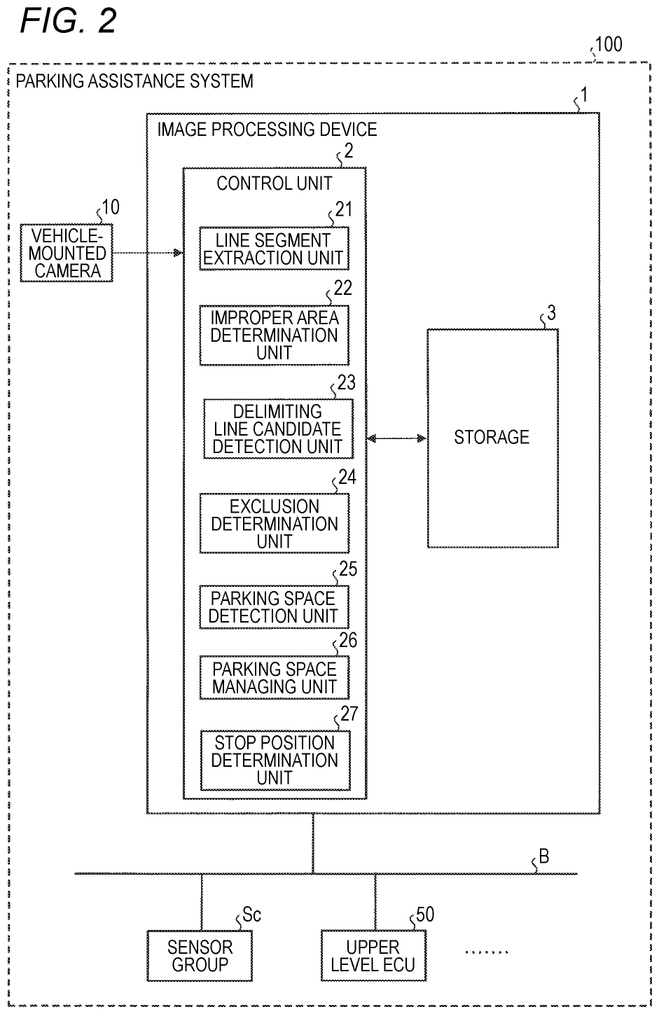

Subsequently, a configuration example of the image processing device 1 of the exemplary embodiment is described with reference to FIG. 2. FIG. 2 is a block diagram of the image processing device 1. In the meantime, FIG. 2 depicts a parking assistance system 100 including the image processing device 1.

As shown in FIG. 2, the parking assistance system 100 includes the image processing device 1, the vehicle-mounted camera 10, a sensor group Sc, and an upper level ECU (Electronic Control Unit) 50. Also, as shown in FIG. 2, the image processing device 1, the sensor group Sc and the upper level ECU 50 can perform communication with one another via a communication bus B of communication protocols of CAN (Control Area Network) communication.

The sensor group Sc includes a variety of sensors configured to detect a traveling state of the vehicle C (refer to FIG. 1A), and is configured to notify detected sensor values to the image processing device 1. The sensor group Sc includes a vehicle speed sensor configured to detect the number of rotations of a wheel of the vehicle C, a steering angle sensor configured to detect a steering angle of the vehicle C, and the like.

The upper level ECU 50 is an ECU configured to support automatic parking of the vehicle C, for example, and is configured to park the vehicle C in the parking space PS, based on the parking space PS detected by the image processing device 1, for example. For example, the upper level ECU 50 is an EPS (Electric Power Steering)-ECU configured to control the steering angle of the vehicle C, and can control the steering angle relative to the parking space PS detected by the image processing device 1. In the meantime, the upper level ECU 50 may include an ECU configured to perform accelerator control and brake control.

As shown in FIG. 2, the image processing device 1 includes a control unit 2 and a storage 3. The control unit 2 includes a line segment extraction unit 21, an improper area determination unit 22, a delimiting line candidate detection unit 23, an exclusion determination unit 24, a parking space detection unit 25, a parking space managing unit 26, and a stop position determination unit 27.

The control unit 2 includes a computer having, for example, a CPU (Central Processing Unit), a ROM (Read Only Memory), a RAM (Random Access Memory), an HDD (Hard Disk Drive), an I/O port, and the like, and a variety of circuits.

The CPU of the computer is configured to read and execute programs stored in the ROM, thereby functioning as the line segment extraction unit 21, the improper area determination unit 22, the delimiting line detection unit 23, the exclusion determination unit 24, the parking space detection unit 25, the parking space managing unit 26 and the stop position determination unit 27 of the control unit 2.

Also, at least some or all of the line segment extraction unit 21, the improper area determination unit 22, the delimiting line detection unit 23, the exclusion determination unit 24, the parking space detection unit 25, the parking space managing unit 26 and the stop position determination unit 27 of the control unit 2 may be configured by hardware such as an ASIC (Application Specific Integrated Circuit), an FPGA (Field Programmable Gate Array) and the like.

The storage 3 corresponds to a RAM and an HDD, for example. The RAM and the HDD can store therein a variety of information and information of diverse programs. In the meantime, the image processing device 1 may be configured to acquire the programs and diverse information through another computer connected with a wired or wireless network, or a portable recording medium.

When it is assumed that the vehicle C travels in the parking lot (for example, the vehicle speed is lower than 30 km/h), for example, the control unit 2 may execute detection processing of the parking space, which will be described later, or may execute the detection processing all during the traveling of the vehicle C.

The line segment extraction unit 21 is configured to detect edge lines connecting edge points based on luminance of each pixel, from the image input from the vehicle-mounted camera 10. Specifically, the line segment extraction unit 21 converts the image input from the vehicle-mounted camera 10 into a gray scale image by performing gray scaling for the image data. The gray scaling is processing of converting each pixel of the image so as to express the same with each gradation (for example, 256 gradations) from white to black, in correspondence to luminance.

The line segment extraction unit 21 may obtain an edge strength of each pixel and a luminance gradient by applying a Sobel filter to the gray scale image, for example. Then, the line segment extraction unit 21 may extract the edge points by extracting pixels having edge strength exceeding a predetermined value, and may extract the edge lines by connecting the adjacent edge points. The line segment extraction unit 21 is configured to notify edge information about the extracted edge points and edge lines to the improper area determination unit 22.

The improper area determination unit 22 is configured to determine whether there is an improper area in which it is difficult to detect the delimiting line L for establishing the parking space PS, based on the edge points and edge lines extracted by the line segment extraction unit 21. For example, the improper area determination unit 22 may determine, as the improper area, a non-paved road surface area (for example, gravels) and a grating area, in which more edge points are extracted, as compared to a paved road surface.

Specifically, the improper area determination unit 22 may determine, as the improper area, an area in which a density of the respective edge points is equal to or greater than a predetermined value and the luminance gradient of the respective edge points is not uniform. The improper area determination unit 22 is configured to remove edge information about the improper area from the edge information, based on the determined improper area, and to provide the resultant information to later processing.

The delimiting line candidate detection unit 23 is configured to detect the delimiting line candidate, which is a candidate of the delimiting line for delimiting the parking space, based on the edge lines extracted by the line segment extraction unit 21. Specifically, the delimiting line candidate detection unit 23 detects, as the delimiting line candidate, edge lines substantially parallel with each other and having an interval belonging to a predetermined range corresponding to a width of the delimiting line.

That is, the delimiting line candidate detection unit 23 detects, as the delimiting line candidate, edge lines corresponding to left and right ends of each delimiting line in a width direction. The delimiting line candidate detection unit 23 is configured to generate delimiting line information about the detected delimiting line candidate and to notify the same to the exclusion determination unit 24.

In the meantime, the delimiting line candidate detection unit 23 may execute the detection processing of the delimiting line candidate, except the improper area detected by the improper area determination unit 22. In other words, the delimiting line candidate detection unit 23 does not execute the detection processing of the delimiting line candidate for the improper area. Thereby, it may be possible to suppress a processing load of the control unit 2.

The exclusion determination unit 24 is configured to determine whether there is a parking-unavailable area in which the parking of the vehicle C is not permitted, based on the delimiting line candidates detected by the delimiting line candidate detection unit 23. For example, the exclusion determination unit 24 determines whether there is a parking-unavailable area such as a stripe area, as the parking-unavailable area.

Specifically, when the delimiting line candidates substantially parallel with each other are assumed as delimiting lines (referred to as ‘support delimiting lines’), if three or more delimiting line candidates inclined to the support delimiting lines are provided with predetermined intervals, the exclusion determination unit 24 regards an area between the support delimiting lines, as a parking-unavailable area.

Also, the exclusion determination unit 24 may determine whether there is a delimiting line candidate, which is not necessary to detect the parking space, such as a road surface marker. For example, the exclusion determination unit 24 may detect each road surface marker included in the image by matching the delimiting line candidate detected by the delimiting line candidate detection unit 23 and a template model of each road surface marker.

The exclusion determination unit 24 is configured to exclude the unnecessary delimiting line candidate from the delimiting line information, to apply the information about the parking-unavailable area to the delimiting line information, and to notify the same to the parking space detection unit 25.

The parking space detection unit 25 is configured to detect the parking spaces, based on the delimiting line candidates detected by the delimiting line candidate detection unit 23. Specifically, the parking space detection unit 25 detects, as the parking space, an area between the delimiting line candidates arranged with a predetermined interval.

Here, the predetermined interval is a width of a standard parking area for general public defined by laws and the like relating to the parking lot. Also, in this case, the parking space detection unit 25 may detect the parking space while avoiding the area determined as the parking-unavailable area by the exclusion determination unit 24.

That is, the parking space detection unit 25 may detect the parking space while avoiding the stripe area and the like. When the parking space detection unit 25 detects the parking space, it notifies parking space information about the parking space to the parking space managing unit 26. Meanwhile, in the below, the delimiting line candidates detected as the delimiting line candidates for delimiting the parking space by the parking space detection unit 25 are referred to as ‘delimiting lines’. Also, the parking space information includes vertex coordinates of each delimiting line based on the vehicle C.

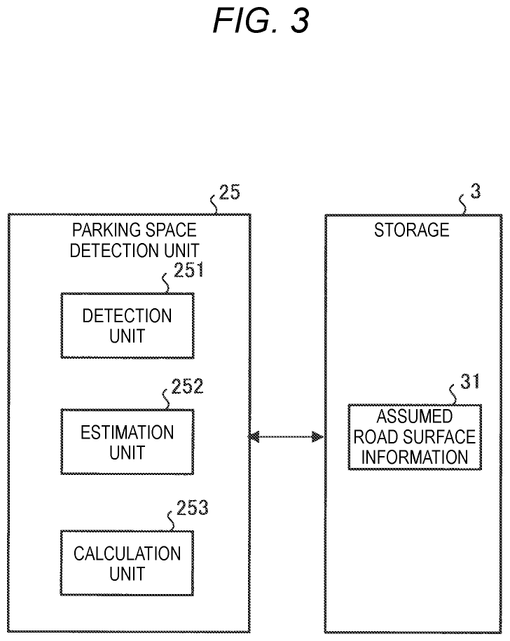

The parking space detection unit 25 is configured to estimate, from the image, an inclination angle of the road surface, on which the delimiting lines are provided, with respect to the road surface on which the vehicle C travels, to calculate positions and angles of the delimiting lines with respect to the vehicle C, based on an estimation result of the inclination angle, and to deduce vertex coordinates of each delimiting line. In the meantime, a specific example of the parking space detection unit 25 will be described later with reference to FIG. 3.

The parking space managing unit 26 is configured to manage the parking spaces detected by the parking space detection unit 25 in chronical order. The parking space managing unit 26 may estimate a moving amount of the vehicle C on the basis of the sensor values input from the sensor group Sc, and estimate the vertex coordinates of each actual delimiting line based on past parking space information, based on the moving amount.

Also, the parking space managing unit 26 may update coordinate information of the delimiting line in the past parking space information, based on the newly input parking space information. That is, the parking space managing unit 26 is configured to frequently update a relative positional relationship between the vehicle C and the parking space, in association with movement of the vehicle C.

Also, the parking space managing unit 26 may set a detection range of the parking space while assuming that a plurality of parking spaces is continuously arranged. For example, the parking space managing unit 26 sets one parking space detected by the parking space detection unit 25, as a reference, and assumes that there is a plurality of parking spaces continuously to the parking space.

The parking space managing unit 26 is configured to set positions of the assumed parking spaces, as a detection range. Thereby, since the line segment extraction unit 21 has only to execute the detection processing of the edge lines only within the detection range set by the parking space managing unit 26, it may be possible to suppress the processing load of the control unit 2.

The stop position determination unit 27 is configured to determine a stop position upon parking of the vehicle C in the parking space PS, based on the edge lines detected by the line segment extraction unit 21. For example, the stop position determination unit 27 determines a stop position of the vehicle C by detecting a wheel block, a curbstone, a wall, a white line extending in a vehicle width direction and the like, based on the edge lines detected by the line segment extraction unit 21.

When a wheel block is detected, the stop position determination unit 27 determines a stop position so that rear wheels of the vehicle C are to be located just before the wheel block. When a white line, a wall and the like are detected, instead of the wheel block, the stop position determination unit 27 determines a stop position so that a rear end (for example, a tip end of a rear bumper) of the vehicle C is to be located just before the white line.

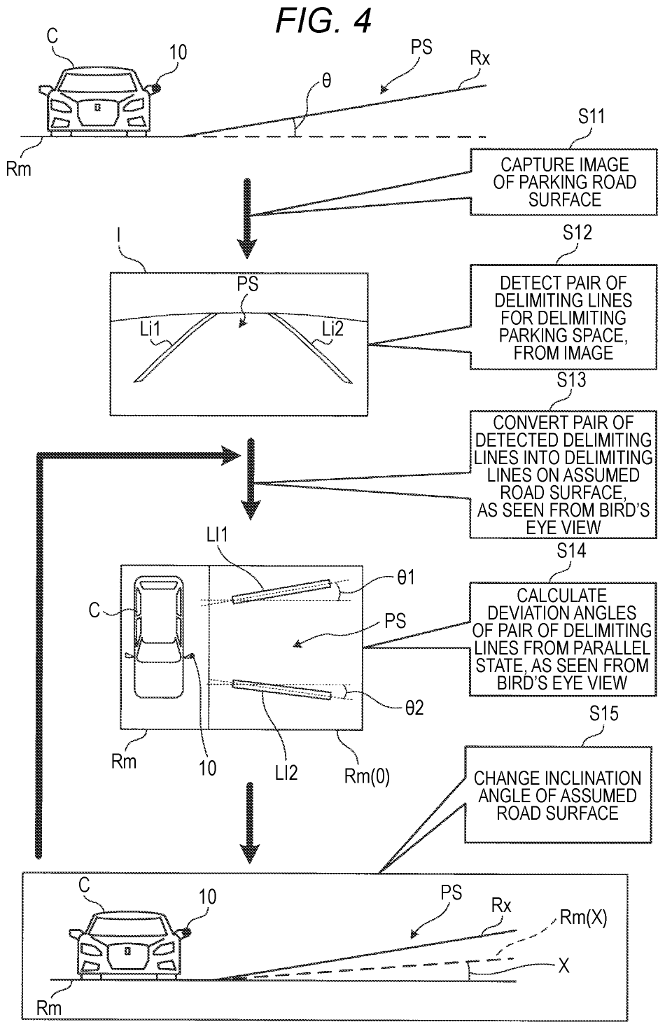

Subsequently, the parking space detection unit 25 of the exemplary embodiment is described in detail with reference to FIGS. 3 to 5. FIG. 3 is a block diagram of the parking space detection unit 25. FIGS. 4 and 5 illustrate an estimation sequence of the inclination angle.

As shown in FIG. 3, the parking space detection unit 25 includes a detection unit 251, an estimation unit 252, and a calculation unit 253. Also, when the parking space detection unit 25 detects the delimiting lines, assumed road surface information 31 is stored in the storage 3.

The assumed road surface information 31 is an image processing program for converting the delimiting line in the image into a delimiting line on each assumed road surface, as seen from a bird's eye view, for each inclination angle of an assumed road surface, which assumes a road surface on which delimiting lines are provided, with respect to the road surface on which the vehicle C travels.

The detection unit 251 is a processing unit configured to detect a pair of delimiting lines for delimiting a parking space, from the image. The estimation unit 252 is a processing unit configured to estimate an inclination angle of an actual road surface, on which a pair of delimiting lines is provided, based on deflection angles of the pair of delimiting lines, which are detected by the detection unit 251, on a road surface.

Also, the calculation unit 253 is a processing unit configured to calculate positions and angles of the delimiting lines on the actual road surface, with respect to the vehicle C, based on the inclination angle estimated by the estimation unit 252. Meanwhile, in the descriptions below, the road surface on which the vehicle C travels is referred to as ‘traveling road surface Rm’, and the road surface on which the delimiting lines are provided is referred to as ‘detection road surface Rx’.

Here, as shown in FIG. 4, the vehicle C may travel ahead of the detection road surface Rx, which is inclined at an ascending slope by an inclination angle θ with respect to the traveling road surface Rm. In this case, an image I of the detection road surface Rx is captured by the vehicle-mounted camera 10 (step S11).

The detection unit 251 detects a pair of delimiting lines Li1 and Li2 for delimiting the parking space PS, from the image I of the detection road surface Rx (step S12). Then, the estimation unit 252 converts the pair of detected delimiting lines Li1 and Li2 into delimiting lines LI1 and LI2 on the assumed road surface, as seen from a bird's eye view (step S13).

At this time, the estimation unit 252 first converts the delimiting lines Li1 and Li2 detected from the image I into the delimiting lines LI1 and LI2 on the assumed road surface Rm (0) of which the inclination angle is set to an initial value “0°”, as seen from a bird's eye view.

Then, the estimation unit 252 calculates deviation angles θ1 and θ2 of the pair of delimiting lines LI1 and LI2, as seen from a bird's eye view, from a parallel state, (step S14). At this time, the delimiting lines LI1 and LI2 as seen from a bird's eye view are in the substantially parallel state (deviation angles θ1 and θ2 are nearly equal to 0°) unless the detection road surface Rx is inclined with respect to the traveling road surface Rm.

However, here, since the detection road surface Rx is inclined at an ascending slope by the inclination angle θ, with respect to the traveling road surface Rm, (the deviation angles θ1 and θ2 are nearly equal to 0°) is not satisfied. Thereby, the estimation unit 252 can determine that the inclination angle of the detection road surface Rx is not 0°.

For this reason, the estimation unit 252 changes the inclination angle of the assumed road surface from “0°” to “X°” (step S15), and executes the processing of steps S12 and S13 by using an assumed road surface Rm (X) of which an inclination angle is “X°”. Thereafter, the estimation unit 252 changes sequentially a value of the inclination angle “X°” in step S15, and repeats the processing of steps S12 and S13.

For example, as shown in FIG. 5, the estimation unit 252 changes sequentially the inclination angle of the assumed road surface from “0°” to “+7°” by 1°, also changes sequentially the inclination angle from “0°” to “−7°” by 1°.

Then, the estimation unit 252 calculates the deviation angles θ1 and θ2 of the delimiting lines LI1 and LI2, as seen from a bird's eye view, on the assumed road surface Rm (−7) to Rm (+7) at each inclination angle, and estimates, as the inclination angle of the detection road surface Rx, the inclination angle of the assumed road surface at the minimum deviation angles θ1 and θ2.

In the example of FIG. 5, on the assumed road surface Rm (+7) at the inclination angle “+7°”, an interval between the delimiting lines LI1 and LI2 becomes narrower away from the vehicle C, and the delimiting lines LI1 and LI2 largely deviate from the parallel state.

In contrast, on the assumed road surface Rm (+3) at the inclination angle “+3°”, the interval between the delimiting lines LI1 and LI2 becomes narrower away from the vehicle C, but the delimiting lines LI1 and LI2 are not in the parallel state.

On the assumed road surface Rm (+2) at the inclination angle “+2°”, the delimiting lines LI1 and LI2 are in the parallel state. In contrast, on the assumed road surface Rm (+1) at the inclination angle “+1°”, the delimiting lines LI1 and LI2 deviate from the parallel state, so that the interval between the delimiting lines LI1 and LI2 becomes larger away from the vehicle C.

Also, on the assumed road surface Rm (0) at the inclination angle “+0°”, the delimiting lines LI1 and LI2 largely deviate from the parallel state. On the assumed road surface Rm (−7) at the inclination angle “−7°”, the interval between the delimiting lines LI1 and LI2 becomes larger away from the vehicle C, and the delimiting lines LI1 and LI2 largely deviate from the parallel state.

For this reason, in the example of FIG. 5, the estimation unit 252 estimates, as the inclination angle of the detection road surface Rx, the inclination angle “+2°” of the assumed road surface Rm (+2) at the minimum deviation angles θ1 and θ2. In this way, since the estimation unit 252 estimates the inclination angle, based on the deflection angles of the delimiting lines LI1 and LI2, which are detected from the image I, on the assumed road surface, it may be possible to estimate the inclination angle of the road surface, on which the delimiting lines are provided, from the image captured by the monocular camera.

Thereafter, in the example of FIG. 5, the calculation unit 253 calculates an angle θ11 and a distance D1 of the delimiting line LI1 on the assumed road surface Rm (+2) with respect to the vehicle C, and calculates an angle θ12 and a distance D2 of the delimiting line LI2 on the assumed road surface Rm (+2) with respect to the vehicle C.

Meanwhile, in FIG. 5, the angles θ11 and 012 and the distances D1 and D2 of one vertex of the respective delimiting lines LI1 and LI2 with respect to the vehicle C are shown. However, the calculation unit 253 calculates angles and distances of the remaining three vertexes of the respective delimiting lines LI1 and LI2 with respect to the vehicle C, too.

Thereby, the calculation unit 253 can calculate the angles and positions of the delimiting lines LI1 and LI2 with respect to the vehicle C. In this way, the calculation unit 253 can calculate the correct angles and positions of the delimiting lines LI1 and LI2 with respect to the vehicle C by using the delimiting lines LI1 and LI2 on the assumed road surface Rm (+2) of which the inclination angle of the detection road surface Rx is estimated by the estimation unit 252.

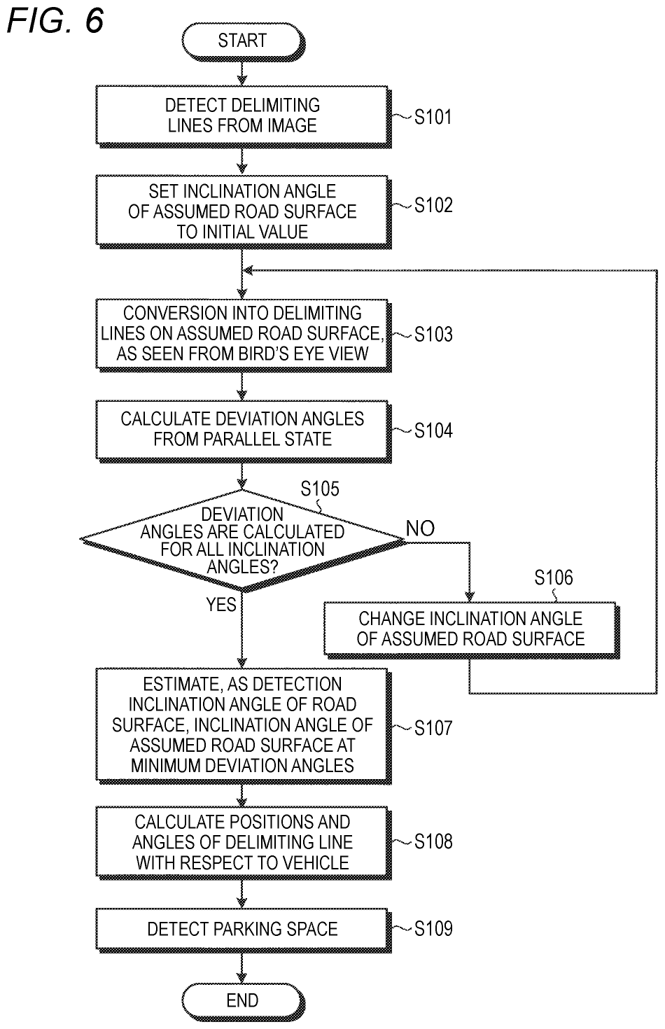

Subsequently, processing that is to be executed by the parking space detection unit 25 is described with reference to FIG. 6. FIG. 6 is a flowchart depicting an example of processing that is to be executed by the parking space detection unit 25. The parking space detection unit 25 repeatedly executes the processing shown in FIG. 5, when it is assumed that the vehicle C travels in the parking lot (for example, the vehicle speed is lower than 30 Km/h), for example.

Specifically, as shown in FIG. 6, the parking space detection unit 25 detects first the delimiting lines from the image (step S101). Then, the parking space detection unit 25 sets the inclination angle of the assumed road surface to an initial value (step S102), and converts the detected delimiting lines into delimiting lines on the assumed road surface, as seen from a bird's eye view (step S103).

Then, the parking space detection unit 25 calculates the deviation angles of the converted delimiting lines from the parallel state (step S104). Then, the parking space detection unit 25 determines whether the deviation angles are calculated for all the inclination angles (step S105).

When it is determined that the deviation angles are not calculated for all the inclination angles (step S105, No), the parking space detection unit 25 changes the inclination angle of the assumed road surface (step S106), and proceeds to step S103.

Also, when it is determined that the deviation angles are calculated for all the inclination angles (step S105, Yes), the parking space detection unit 25 determines, as the detection inclination angle of the road surface, the inclination angle of the assumed road surface at the minimum deviation angle (step S107).

Thereafter, the parking space detection unit 25 detects the positions and angles of the delimiting lines with respect to the vehicle, based on the estimated inclination angle (step S108). Finally, the parking space detection unit 25 detects the parking space, based on the calculated positions and angles of the delimiting lines with respect to the vehicle (step S109), and ends the processing.

In the exemplary embodiment, the initial value of the assumed road surface is set to “0°”. However, this is merely exemplary. The estimation unit 252 may set the initial value of the assumed road surface to “−7°” and increase the same up to “+7°” by 1° or may set the initial value of the assumed road surface to “+7°” and decrease the same up to “−7°” by 1°.

Also, the angle range of the assumed road surface is not limited to the range from “−7°” to “+7°”, and may be any angle range. Also, the amount of change in inclination angle of the assumed road surface is not limited to 1°, and may be arbitrarily set.

Also, in the exemplary embodiment, the estimation unit 252 converts the delimiting lines into the delimiting lines on the assumed road surface, as seen from a bird's eye view, for all the assumed inclination angles, and calculates the deviation angles from the parallel state. However, the change of the inclination angle of the assumed road surface may be stopped at time at which the minimum deviation angles are determined.

Also, the image processing device 1 may have a configuration in which a table, in which the deflection angles of the pair of delimiting lines on the road surface in the image are associated with the inclination angles of the detection road surface, is stored in the storage 3. In this configuration, the estimation unit 252 calculates the deflection angles of the pair of delimiting lines on the road surface in the image obtained by capturing the surrounding of the vehicle C.

Then, the estimation unit 252 selects an inclination angle associated with the calculated deflection angles from the table, and estimates the selected inclination angle, as the inclination angle of the detection road surface. According to this configuration, since it is not necessary to estimate the inclination angle while repeatedly changing the inclination angle of the assumed road surface, it may be possible to reduce the processing load.

The additional effects and modified embodiments can be easily deduced by one skilled in the art. For this reason, the wider aspect of the present disclosure is not limited to the specific details and exemplary embodiments as described above. Therefore, a variety of changes can be made without departing from the spirit and scope of the concept of the general invention defined by the claims and equivalents thereof

What is claimed is:

1. An image processing device comprising:
a detection unit configured to detect, from an image, a pair of delimiting lines for delimiting a parking space; and
an estimation unit configured to estimate an inclination angle of an actual road surface on which the pair of delimiting lines is provided based on deflection angles of the pair of delimiting lines on a road surface, the pair of delimiting lines being included in the at least one delimiting line detected by the detection unit.

2. The image processing device according to claim 1, wherein
the estimation unit estimates the inclination angle of the actual road surface at an inclination angle of a first assumed road surface determined from among a plurality of assumed road surfaces on each of which converted delimiting lines which are converted from the pair of delimiting lines are provided, the plurality of assumed road surfaces having different inclination angles as seen from a bird's eye view, the first assumed road surface being determined such that deviation angles of a pair of converted delimiting lines provided on the first assumed road surface from a parallel state is smallest of deviation angles on the plurality of assumed road surfaces.

3. The image processing device according to claim 1, further comprising
a storage configured to store a table in which deflection angles of a pair of delimiting lines on a road surface in an image and inclination angles of the actual road surface are associated, wherein
the estimation unit is configured to calculate the deflection angles of the pair of delimiting lines on the road surface in the image obtained by capturing a surrounding of a vehicle, to select an inclination angle associated with the deflection angles calculated in the table, and to estimate the inclination angle of the actual road surface at the inclination angle selected.

4. The image processing device according to claim 1, further comprising
a calculation unit configured to calculate, based on the inclination angle estimated by the estimation unit, positions and angles of the pair of delimiting lines on the actual road surface with respect to a vehicle on which an imaging device configured to capture the image is mounted.

5. The image processing device according to claim 2, further comprising
a calculation unit configured to calculate, based on the inclination angle estimated by the estimation unit, positions and angles of the pair of delimiting lines on the actual road surface with respect to a vehicle on which an imaging device configured to capture the image is mounted.

6. The image processing device according to claim 3, further comprising
a calculation unit configured to calculate, based on the inclination angle estimated by the estimation unit, positions and angles of the pair of delimiting lines on the actual road surface with respect to a vehicle on which an imaging device configured to capture the image is mounted.

7. An image processing method comprising:
detecting, from an image, a pair of delimiting lines for delimiting a parking space; and
estimating an inclination angle of an actual road surface on which the pair of delimiting lines is provided based on deflection angles of the pair of delimiting lines on a road surface, the pair of delimiting lines being included in the at least one delimiting line detected.
